(19) United States
(12) Patent Application Publication
(10) Pub. No.: US 2024/0351355 A1
(43) Pub. Date: Oct. 24, 2024

(54) RECORDING APPARATUS

(71) Applicant: CANON KABUSHIKI KAISHA, Tokyo (JP)

(72) Inventors: MASAAKI MATSUURA, Kanagawa (JP); KEISEI HAKAMATA, Kanagawa (JP); YUKI EMOTO, Tokyo (JP); MAYU TAKECHI, Kanagawa (JP); SATORU NITOBE, Kanagawa (JP)

(21) Appl. No.: 18/638,439

(22) Filed: Apr. 17, 2024

(30) Foreign Application Priority Data
Apr. 20, 2023 (JP) 2023-069679

(51) Int. Cl. B41J 13/00; B65H 5/06

(52) U.S. Cl. CPC B41J 13/0027; B65H 5/062; B65H 2513/10

(57) ABSTRACT

A recording apparatus includes a recording unit configured to record an image onto a sheet, a first conveyance roller configured to convey the sheet, a motor configured to drive the first conveyance roller, and a control unit configured to repetitively perform control for accelerating the motor in an acceleration period and then decelerating the motor in a deceleration period, wherein, in at least a part of the deceleration period, the control unit makes an absolute value of a second deceleration in a second control of the motor smaller than an absolute value of a first deceleration in a first control of the motor, the first control being performed in a case where a trailing edge of the sheet does not stop in a first predetermined region, the second control being performed in a case where the trailing edge of the sheet stops in the first predetermined region.

### BACKGROUND

### Field

The present disclosure relates to conveyance control for a recording apparatus.

### Description of the Related Art

Serial type recording apparatuses form an image on a sheet by repetitively performing a conveyance operation and a discharge operation. In the conveyance operation, a conveyance roller conveys the sheet in the conveyance direction. In the discharge operation, a recording head discharges ink while moving in the direction perpendicularly intersecting with the conveyance direction. Therefore, if the stop position of the conveyed sheet deviates from a target stop position, the image quality of the image formed on the sheet deteriorates. Japanese Patent Application Laid-Open No. 2006-272893 discusses a technique for conveying a sheet to a target stop position while reducing the influence of a periodic torque variation occurring in a drive system of a conveyance roller.

However, a recording apparatus discussed in Japanese Patent Application Laid-Open No. 2006-272893 cannot cope with a sudden load variation occurring in the drive system when the trailing edge of the sheet passes through the conveyance roller. In this case, the target stop position of the sheet will deviate from a target position. The above-described issue arises in controlling the drive system of the conveyance roller.

### SUMMARY

According to some embodiments, a recording apparatus includes a recording unit configured to record an image onto a sheet, a first conveyance roller configured to convey the sheet in a conveyance direction to the recording unit, a motor configured to drive the first conveyance roller, and a control unit configured to repetitively perform control for accelerating the motor in an acceleration period and then decelerating the motor in a deceleration period, wherein, in at least a part of the deceleration period, the control unit makes an absolute value of a second deceleration in a second control of the motor smaller than an absolute value of a first deceleration in a first control of the motor, the first control being performed in a case where a trailing edge of the sheet in the conveyance direction does not stop in a first predetermined region, the second control being performed in a case where the trailing edge of the sheet stops in the first predetermined region.

Further features of the present disclosure will become apparent from the following description of exemplary embodiments with reference to the attached drawings.

### BRIEF DESCRIPTION OF THE DRAWINGS

FIG. 1 is a perspective view illustrating an inner structure of a recording apparatus.

FIG. 2 is a cross-sectional view illustrating a feeding unit and a conveyance unit of the recording apparatus.

FIG. 3 is a perspective view illustrating a structure of the conveyance unit.

FIG. 4 is a schematic view illustrating a conveyance path.

FIG. 5 is a block diagram illustrating a control configuration of the recording apparatus.

FIG. 6 is a flowchart illustrating a recording operation.

FIG. 7 is a flowchart illustrating drive switching.

FIGS. 8A, 8B, and 8C are schematic views illustrating relations between a trailing edge position of a sheet and a conveyance amount.

FIGS. 9A and 9B are schematic views illustrating relations between a trailing edge position of a sheet and a conveyance amount.

FIGS. 10A and 10B are conceptual views illustrating profiles of a drive motor during a conveyance operation.

FIGS. 11A and 11B are conceptual views illustrating profiles of the drive motor during the conveyance operation.

FIGS. 12A and 12B are conceptual views illustrating profiles of the drive motor during the conveyance operation.

### DESCRIPTION OF THE EMBODIMENTS

Various exemplary embodiments, features, and aspects will be described in detail below with reference to the accompanying drawings. The following exemplary embodiments do not limit the present disclosure within the scope of the appended claims. Although a plurality of features is described in the exemplary embodiments, not all of the plurality of features is indispensable to the present disclosure, and the plurality of features may be arbitrarily combined. In the accompanying drawings, identical or similar components are assigned the same reference numerals, and duplicated descriptions thereof will be omitted.

### <Recording Apparatus>

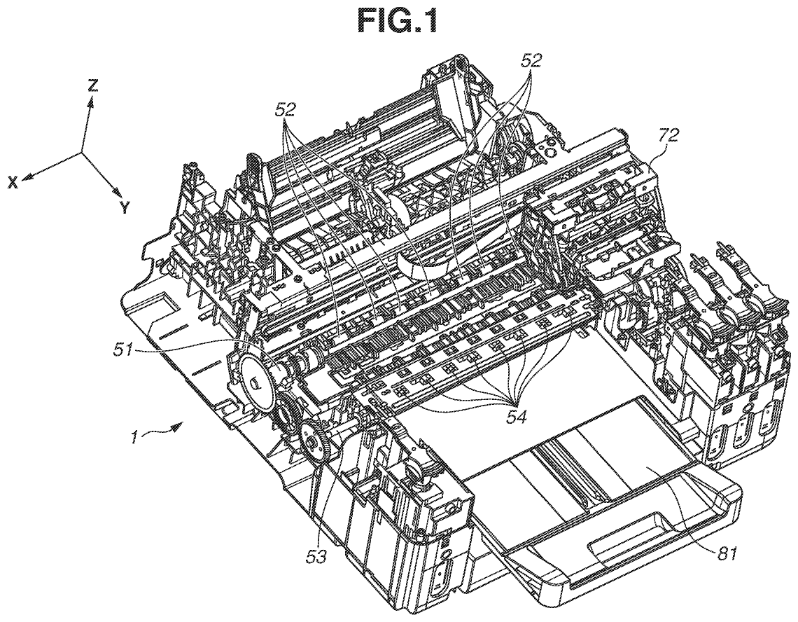

A recording apparatus according to a first exemplary embodiment will be described below with reference to FIGS. 1 to 4. A recording apparatus 1 is a serial type inkjet recording apparatus that discharges ink onto a sheet for image recording.

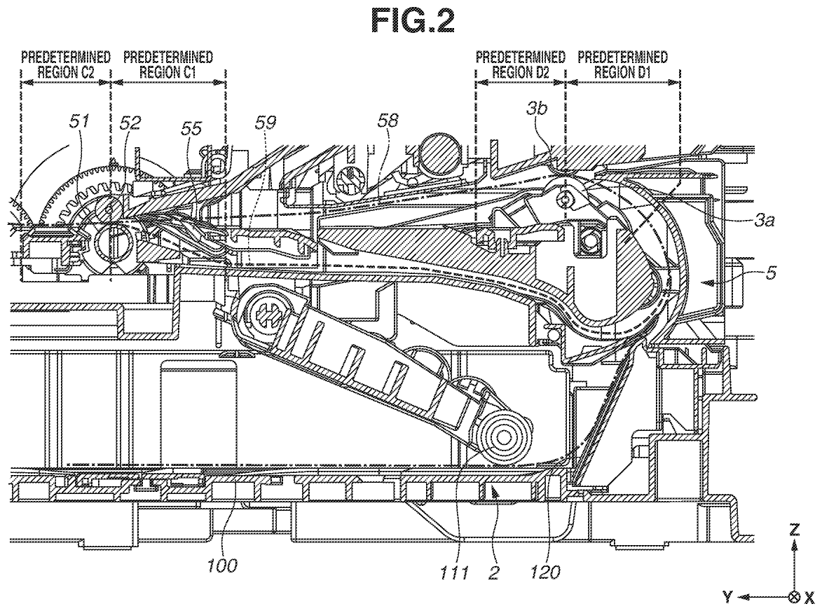

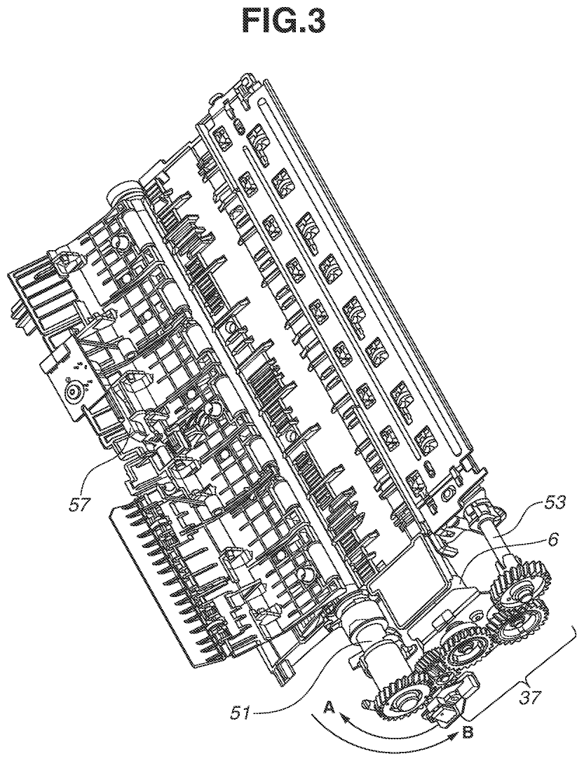

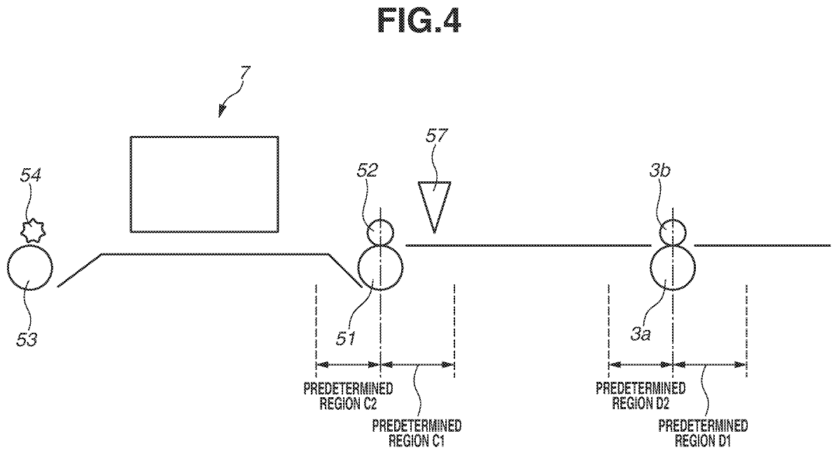

FIG. 1 is a perspective view illustrating an inner structure of the recording apparatus 1. FIG. 2 is a cross-sectional view illustrating a feeding unit and a conveyance unit of the recording apparatus 1. FIG. 3 is a perspective view illustrating a structure of the conveyance unit. FIG. 4 is a schematic view illustrating a conveyance path. The recording apparatus 1 includes a feeding unit 2, a conveyance unit 5, a recording unit 7, and a sheet discharge unit 8. Referring to FIG. 2, the dash-dot line indicates the sheet conveyance path ranging from the feeding unit 2 to the conveyance unit 5. The dotted line indicates a reversing path 59 for reversing a sheet. The sheet having been fed by the feeding unit 2 is conveyed by the conveyance unit 5. Then, an image is recorded on the sheet by the recording unit 7, and the sheet is discharged by the sheet discharge unit 8. When recording an image on the back surface of the sheet, the sheet with an image recorded on the front surface is fed to the conveyance unit 5 along the reversing path 59. The direction in which the sheet is conveyed from the conveyance unit 5 to the recording unit 7 is referred to as a conveyance direction.

The feeding unit 2 includes a cassette 100, a pickup roller 111, and a separation unit 120. The cassette 100 disposed at the lower part of the housing of the recording apparatus 1 can store a plurality of sheets. The pickup roller 111 picks up the top sheet from the cassette 100 rotatably disposed in the housing. The separation unit 120 forms a part of the conveyance path to separate a sheet from sheets having been doubly fed by the pickup roller 111. The feeding unit 2 may be an automatic sheet feeder (ASF) disposed on the back side of the recording apparatus 1.

The conveyance unit 5 includes a conveyance roller 51, intermediate rollers 3a and 3b, a flapper 55, a conveyance path 58, and the reversing path 59. The conveyance roller 51 and the intermediate rollers 3a and 3b are disposed in the conveyance path 58 up to the conveyance unit 5. Pinch rollers 52 are disposed to face the conveyance roller 51, and a sheet is conveyed while being pinched by the conveyance roller 51 and the pinch rollers 52. According to the present disclosure, the conveyance roller may refer to a pair of the conveyance roller 51 and the pinch roller 52. In the conveyance path 58, predetermined regions C1 and C2 are set upstream and downstream of the conveyance roller 51, respectively, to change the conveyance control by the conveyance roller 51. Each predetermined region ranges, for example, 2 to 15 mm (millimeters). The intermediate rollers 3a and 3b are disposed between the conveyance roller 51 and the pickup roller 111 in the conveyance path 58. The intermediate rollers 3a and 3b include intermediate rollers 3a and 3b facing each other, and a sheet is conveyed while being pinched by the intermediate rollers 3a and 3b. According to the present disclosure, the intermediate rollers 3 may refer to a pair of the intermediate rollers 3a and 3b. In the conveyance path 58, predetermined regions D1 and D2 are set upstream and downstream of the intermediate rollers 3a and 3b, respectively, to change the conveyance control by the intermediate rollers 3a and 3b. An edge detection lever 57 for detecting the edges of the sheet is disposed upstream of the conveyance roller 51 and downstream of the intermediate rollers 3a and 3b in the conveyance direction. When the sheet edge rotates the edge detection lever 57, the leading and trailing edges of the sheet are detected. An optical sensor may also be used to detect the edges of the sheet. The predetermined regions may be set only for the conveyance roller 51 or only for the intermediate rollers 3a and 3b. The predetermined regions may be disposed only downstream of the rollers or only upstream thereof. Further, the predetermined regions may be set at curved portions of the conveyance path 58 or the separation unit 120.

The recording unit 7 records an image on a sheet having been conveyed in the conveyance direction by the conveyance roller 51. The recording unit 7 includes a recording head 71 for discharging ink, and a carriage 72 that mounts the recording head 71 and makes a reciprocating motion in the sheet width direction perpendicularly intersecting with the conveyance direction. When the recording head 71 moves in the sheet width direction by the carriage 72 while discharging ink, an image is recorded on the sheet.

The sheet discharge unit 8 includes a discharge roller 53, a conveyance path 58, and a discharge tray 81. Spur rollers 54 are disposed to face the discharge roller 53. When an image is recorded on one side or both sides of the sheet by the recording unit 7, the sheet is discharged to the discharge tray 81 by the discharge roller 53.

The drive motor 6 transmits a driving force to the conveyance roller 51, the discharge roller 53, the intermediate roller 3a, and the pickup roller 111 via a gear train 37. More specifically, the drive motor 6 can drive the plurality of rollers for conveying a sheet. Referring to FIG. 3, when the drive motor 6 drives the conveyance roller 51 in the direction of the arrow A, the conveyance roller 51 and the discharge roller 53 convey a sheet downstream in the conveyance direction. The rotational direction of the drive motor 6 in this case is referred to as a forward direction. On the other hand, when the drive motor 6 drives the conveyance roller 51 in the direction of the arrow B, the conveyance roller 51 and the discharge roller 53 convey a sheet upstream in the conveyance direction. The rotational direction of the drive motor 6 in this case is referred to as a reverse direction. The rotational direction of the drive motor 6 can be changed by changing the voltage polarity. The driving amount of the drive motor 6 is detected by an encoder 813. The position and speed of the drive motor 6 are controlled through various control such as proportional-integral-differential (PID) control. The encoder 813 is coaxial with the conveyance roller 51 but may be coaxial with the drive motor 6. The conveyance amount of the sheet can be calculated based on the rotation amount of the encoder 813.

A recording operation will be briefly described below. A sheet having been fed by the pickup roller 111 is conveyed by the intermediate rollers 3a and 3b. Then, the sheet reaches the conveyance roller 51 while pushing down a flapper biased by a spring. The conveyance roller 51 conveys a sheet to the recording position where recording is made by the recording unit 7. In the recording operation, the recording apparatus 1 alternately performs a sheet conveyance operation by the conveyance roller 51 and an ink discharge operation by the recording unit 7. In one-sided recording, the sheet with an image recorded thereon is discharged from the sheet discharge unit 8. In double-sided recording, the sheet with an image recorded thereon by the recording unit 7 is conveyed in the direction opposite to the conveyance direction by the discharge roller 53 and the conveyance roller 51, and then guided to the reversing path 59 by the flapper 55. The sheet having passed through the reversing path 59 is conveyed to the conveyance unit 5 again. Then, the sheet having been conveyed in the conveyance direction by the conveyance roller 51 is subjected to image recording on the back surface by the recording unit 7. The sheet with an image recorded thereon is discharged from the sheet discharge unit 8.

### <Control Configuration>

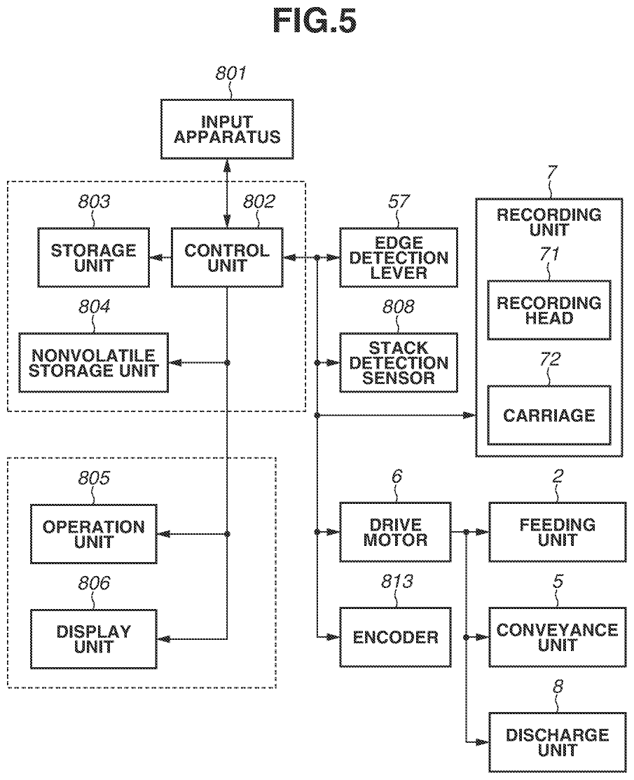

FIG. 5 is a block diagram illustrating control configuration of the recording apparatus 1. A control unit 802 is, for example, a central processing unit (CPU) or other processing unit that totally controls the recording apparatus 1, and can include one or more processors, circuitry, or combinations thereof. A storage unit 803 includes a read only memory (ROM) and a random access memory (RAM). The ROM stores various programs. The RAM provides a system working memory for the operation of the CPU as the control unit 802, and is also used to temporarily store various data. The control unit 802 reads and executes a program stored in the ROM to perform various functions of the recording apparatus 1. A nonvolatile storage unit 804 is, for example, a hard disk drive (HDD) that stores various programs and data.

An operation unit 805 receives a user operation. The operation unit 805 includes a touch panel and hardware keys. The control unit 802 controls the operation of the recording apparatus 1 according to the contents of a user instruction from the operation unit 805. The control unit 802 can also receive instructions related to the operation of the recording apparatus 1 from an input apparatus 801 such as a personal computer (PC) and a smart phone. A display unit 806 displays various information.

The control unit 802 acquires detection results by the edge detection lever 57, a stack detection sensor 808, and the encoder 813, and controls the drive motor 6 and the recording unit 7 based on these detection results.

When the drive motor 6 is controlled by the control unit 802, various rollers included in the feeding unit 2 and the conveyance unit 5 are driven. The stack detection sensor 808 detects the stacking state of sheets in the cassette 100. The encoder 813 detects the driving amount of the drive motor 6. The length of the sheet can be calculated based on the edge detection lever 57 and the driving amount of the drive motor 6. More specifically, the edge detection lever 57 detects the leading edge of the sheet in the feeding operation and the trailing edge of the sheet in the recording or the discharge operation. Then, the control unit 802 calculates the length of the sheet based on the driving amount of the drive motor 6 since the detection of the leading edge of the sheet till the detection of the trailing edge of the sheet. With reference to the recording start position in the recording unit 7, the trailing edge position may be calculated based on the conveyance amount after starting recording or the logical length of the sheet. The trailing edge position may be calculated based on the conveyance amount after the edge detection lever 57 detects the leading or the trailing edge position of the sheet or the logical length of the sheet.

The drive motor 6 is a direct-current (DC) motor. The control unit 802 controls the DC motor with the pulse width modulation (PWM) for modulating a signal with the pulse duty ratio. The driver for driving the drive motor 6 may have a part of the control function. In a serial type recording apparatus, the drive motor 6 repetitively performs a driving cycle including an acceleration period for increasing the rotational speed, a constant-speed period for maintaining a constant rotational speed, and a deceleration period for decreasing the rotational speed. The control unit 802 controls the voltage (PWM value) to be supplied to the drive motor 6 based on drive data so that the drive motor 6 rotates at a target rotational speed. However, if the load of the drive system varies, a difference occurs between the rotational speed of the drive motor 6 based on the detection result by the encoder 813 and the target rotational speed of the drive motor 6. Accordingly, the control unit 802 adjusts the PWM value to minimize the difference between the detected rotational speed and the target rotational speed. According to the present exemplary embodiment, when the trailing edge of the sheet is conveyed to a predetermined region of the conveyance roller 51 or the intermediate rollers 3a and 3b, the control unit 802 performs the drive switching for changing the drive data.

### <Recording Operation>

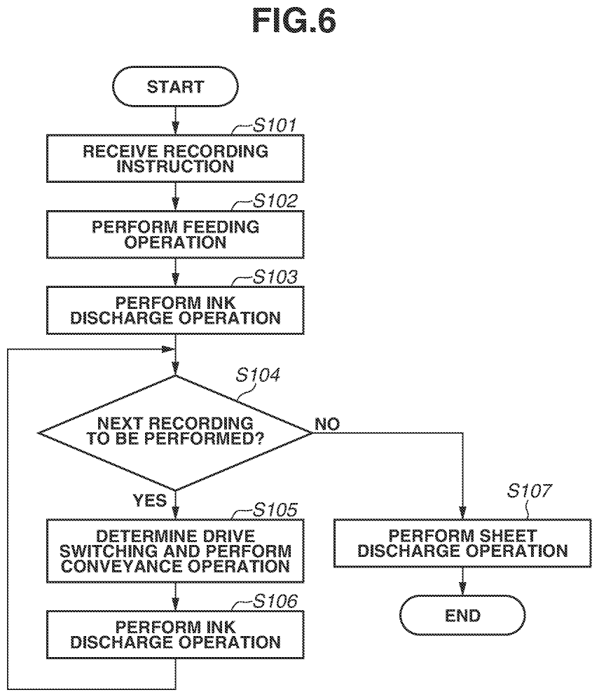

A recording operation for one sheet will be described below. FIG. 6 is a flowchart illustrating a recording operation. In the case of a recording job for performing recording on a plurality of sheets, the control unit 802 repetitively performs the flowchart in FIG. 6 until recording is completed for all pages included in the recording job.

In step S101, the control unit 802 receives a recording instruction from the user via the operation unit 805 or the input apparatus 801.

In step S102, the control unit 802 performs a feeding operation. Firstly, the control unit 802 drives the pickup roller 111 via the drive motor 6 to feed the top sheet of the sheets stacked on the cassette 100. The sheet having been fed by the pickup roller 111 is conveyed to the recording head 71 by the intermediate rollers 3a and 3b and the conveyance roller 51. In this process, the leading or the trailing edge of the sheet is detected by the edge detection lever 57.

In step S103, the control unit 802 subjects the conveyed sheet to an ink discharge operation by the recording head 71. The recording head 71 performs one-pass recording for discharging ink to a sheet while moving in the sheet width direction. In the one-pass recording, the control unit 802 conveys the sheet by a predetermined conveyance amount corresponding to the nozzle length of the recording head 71 in the conveyance direction in each conveyance operation. Multi-pass recording is also possible. In the multi-pass recording, the control unit 802 conveys the sheet by a predetermined conveyance amount corresponding to the number of passes in each conveyance operation. In two-pass recording, for example, the predetermined conveyance amount is a half of the nozzle length.

In step S104, the control unit 802 determines whether to perform the next one-pass recording by the recording head 71. When the control unit 802 determines to perform the next one-pass recording (YES in step S104), the processing proceeds to step S105. When recording has been performed on the entire recording region of the sheet, i.e., when the control unit 802 determines not to perform the next one-pass recording (NO in step S104), the processing proceeds to step S107.

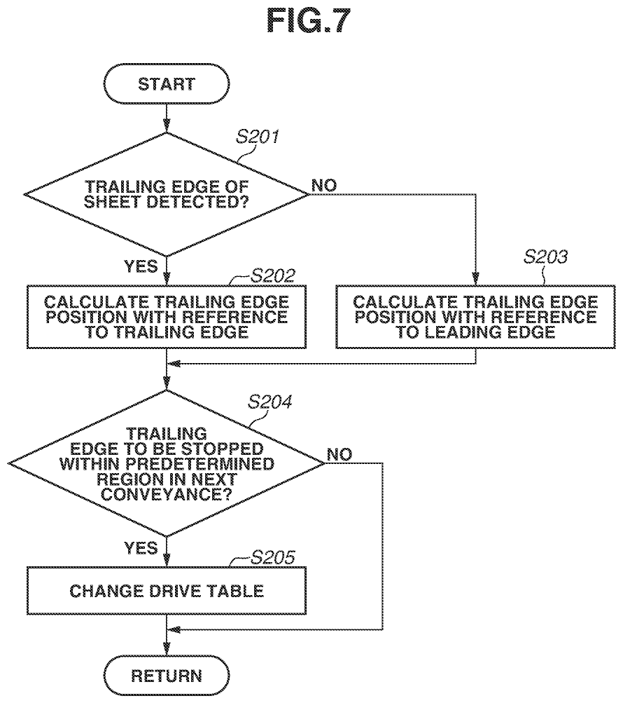

In step S105, the control unit 802 determines whether to perform the drive switching for changing the drive table and performs a conveyance operation for conveying the sheet with the predetermined conveyance amount in the one-pass recording. When the drive switching is not to be performed, the control unit 802 performs a control of the drive motor 6 for a normal conveyance operation. On the other hand, when the drive switching is to be performed, the control unit 802 performs a control of the drive motor 6 for the conveyance operation after the drive switching. The drive switching will be described in detail below with reference to FIG. 7.

In step S106, the control unit 802 subjects the conveyed sheet to an ink discharge operation by the recording head 71. More specifically, the recording head 71 performs the one-pass recording while moving in sheet width direction. After step S106, the processing returns to step S104. The control unit 802 repetitively performs steps S104 to S106 to alternately perform the conveyance and discharge operations to perform recording on the entire recording region of the sheet.

In step S107, the control unit 802 drives the discharge roller 53 via the drive motor 6 to discharge the sheet after the recording to the discharge tray 81. If there is no subsequent page to be subjected to the recording, the control unit 802 completes the recording operation.

If the edge detection lever 57, the stack detection sensor 808, or the encoder 813 detects a failure during execution of the flowchart, the control unit 802 displays the contents of an error or an instruction to the user on the display unit 806. The contents of an error include a sheet jam, paper out, and ink out.

The conveyance operation will be described below. In each conveyance operation for conveying a sheet, the drive motor 6 accelerates in the acceleration period, rotates at a predetermined rotational speed in the constant-speed period, and then decelerates in the deceleration period based on the drive table. More specifically, the sheet accelerates in the acceleration period, moves at a predetermined speed in the constant-speed period, and decelerates in the deceleration period. As a result, the sheet is conveyed by the predetermined conveyance amount. By repetitively performing the conveyance operation, an image is recorded in the entire recording region of the sheet.

If the error of the sheet stop position by the load variation increases when the trailing edge of the sheet passes through the conveyance roller 51, the control unit 802 performs the drive switching for changing the drive table of the drive motor 6. More specifically, the control unit 802 performs the conveyance operation control after the drive switching from the normal conveyance operation control. The control unit 802 may perform the drive switching when the trailing edge of the sheet stops in the predetermined region C2 downstream of the conveyance roller 51 in the next conveyance. However, actually, there are variations in the sheet length and variations in the positions of the edge detection lever 57 and the conveyance roller 51.

Therefore, the control unit 802 also needs to perform the drive switching when the trailing edge of the sheet stops in the predetermined region C1 upstream of the conveyance roller 51. Therefore, the following description will be made on the premise that the predetermined regions cover both the predetermined regions on the upstream side and the downstream side of the conveyance roller 51.

FIG. 7 is a flowchart illustrating the drive switching. In step S201, the control unit 802 determines whether the edge detection lever 57 has detected the trailing edge of the sheet. If the control unit 802 determines having detected the trailing edge of the sheet (YES in step S201), the processing proceeds to step S202. In step S202, the control unit 802 calculates the trailing edge position of the sheet with reference to the trailing edge of the sheet. If the control unit 802 determines having not detected the trailing edge of the sheet (NO in step S201), the processing proceeds to step S203. In step S203, the control unit 802 calculates the trailing edge position of the sheet with reference to the leading edge of the sheet.

In step S204, the control unit 802 determines whether, during the conveyance operation immediately following the one-pass recording, the trailing edge position of the sheet stops within the range from the predetermined region C1 upstream of the conveyance roller 51 to the predetermined region C2 downstream thereof in the conveyance direction. If the trailing edge stops within the relevant range of the predetermined regions (YES in step S204), the processing proceeds to step S205.

In step S205, the control unit 802 changes the drive table to make the absolute value of the deceleration smaller than the absolute value for the normal conveyance operation in the deceleration period. Further, based on this drive table, the control unit 802 does not apply a voltage with a negative duty ratio to the drive motor 6 in the deceleration period. In step S105, the control unit 802 performs the conveyance operation based on the drive table after the drive switching.

On the other hand, if the control unit 802 determines that, during the conveyance operation immediately following the one-pass recording, the trailing edge position of the sheet does not stop in the predetermined region C1 upstream of the conveyance roller 51 or the predetermined region C2 downstream thereof in the conveyance direction (NO in step S204), the processing returns to step S105. In step S105, the control unit 802 performs the conveyance operation based on the normal drive table without changing the drive table.

In step S204, the control unit 802 may determine whether, during the conveyance operation immediately following the one-pass recording, the trailing edge position of the sheet stops within the range from the predetermined region D1 upstream of the intermediate rollers 3a and 3b to the predetermined region D2 downstream thereof in the conveyance direction. If the trailing edge position stops within the relevant range of the predetermined regions (YES in step S204), the control unit 802 changes the drive table to make the absolute value of the deceleration smaller than the absolute value for the normal conveyance operation in the deceleration period. Further, based on the drive table, the control unit 802 does not apply a voltage with a negative duty ratio to the drive motor 6 in the deceleration period.

### <Drive Switching>

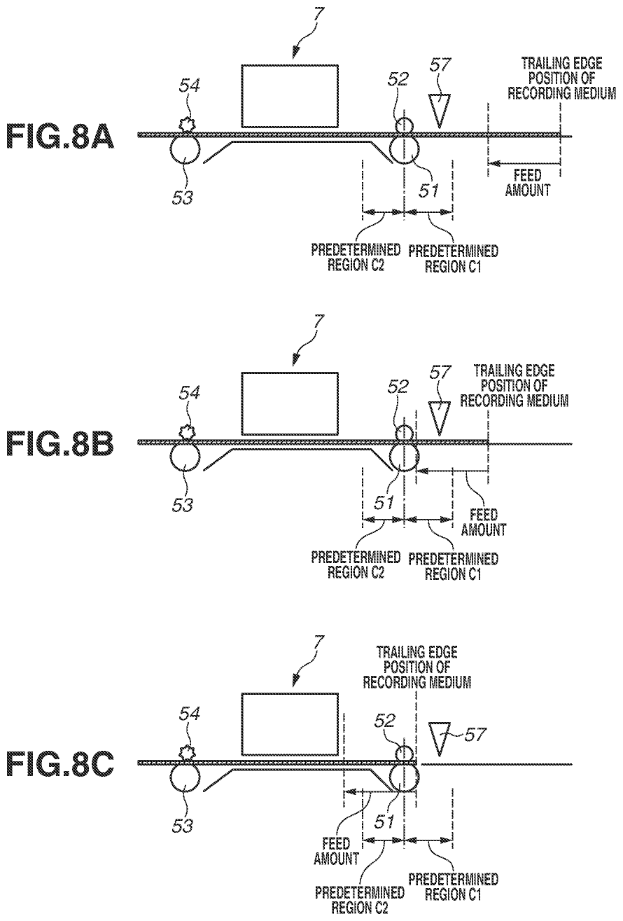

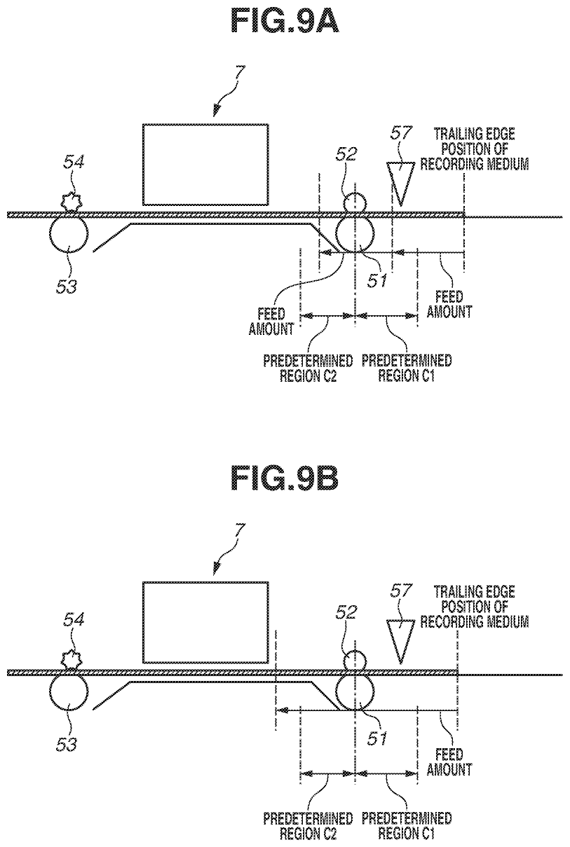

The drive switching will be described below with reference to FIGS. 8A to 8C, 9A, and 9B. FIGS. 8A to 8C, 9A, and 9B are schematic views illustrating relations between the trailing edge position of the sheet and the conveyance amount of the sheet. The FEED amount in FIGS. 8A to 8C, 9A, and 9B refers to a predetermined conveyance amount corresponding to the one-pass recording. Performing the drive switching enables restricting a stop position error due to sudden load variation when the trailing edge of the sheet passes through the conveyance roller 51.

Referring to FIG. 8A, the trailing edge position of the sheet is positioned upstream of the predetermined regions and does not reach the predetermined regions in the conveyance immediately following the one-pass recording. In this case, the control unit 802 performs the conveyance operation based on the normal drive table. More specifically, the control unit 802 repetitively performs the normal conveyance operation until the trailing edge position of the sheet reaches the predetermined regions. Referring to FIG. 8B, the trailing edge position of the sheet stops in the predetermined regions in the conveyance immediately following the one-pass recording. In this case, the control unit 802 changes the drive from the normal conveyance and performs the conveyance operation based on the drive table after the drive switching. Referring to FIG. 8C, the trailing edge position of the sheet is conveyed from the predetermined regions to the downstream side thereof in the conveyance immediately following the one-pass recording. In this case, the control unit 802 performs the conveyance operation based on the normal drive table even before the trailing edge of the sheet passes through the conveyance roller 51. This is because the trailing edge of the sheet passes through the conveyance roller 51 and stops over a prolonged period of time, and hence the correction of the stop position error is completed within a predetermined time. After the trailing edge position of the sheet is conveyed downstream of the predetermined regions, the control unit 802 repetitively performs the conveyance operation based on the normal drive table.

Referring to FIG. 9A, the trailing edge position of the sheet stops in the predetermined regions in the conveyance immediately following the one-pass recording and further stops in the predetermined regions in the conveyance immediately following the one-pass recording. In this case, the control unit 802 performs the drive switching in succession. More specifically, the control unit 802 performs the conveyance operation twice in succession based on the drive table after the drive switching. The predetermined conveyance amount decreases with increasing number of passes. Therefore, the possibility that the drive switching is performed in succession increases with increasing number of passes. Referring to FIG. 9B, the trailing edge position of the sheet passes through the predetermined regions from the upstream thereof and then stops downstream of the predetermined regions in the conveyance immediately following the one-pass recording. In this case, the control unit 802 does not perform the drive switching. This is because the trailing edge of the sheet passes through the conveyance roller 51 and stops over a prolonged period of time, and hence the correction of the stop position error is completed within a predetermined time.

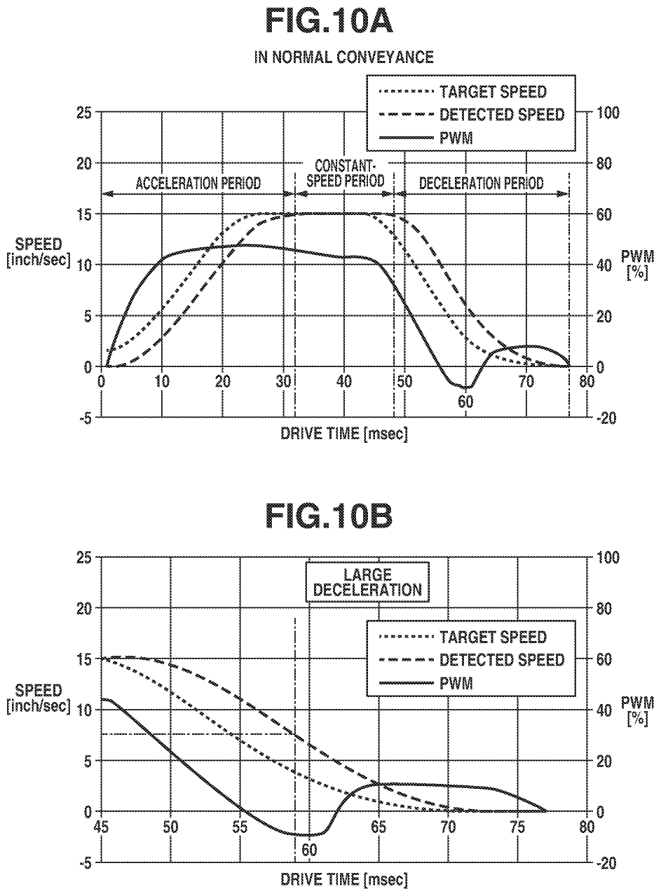

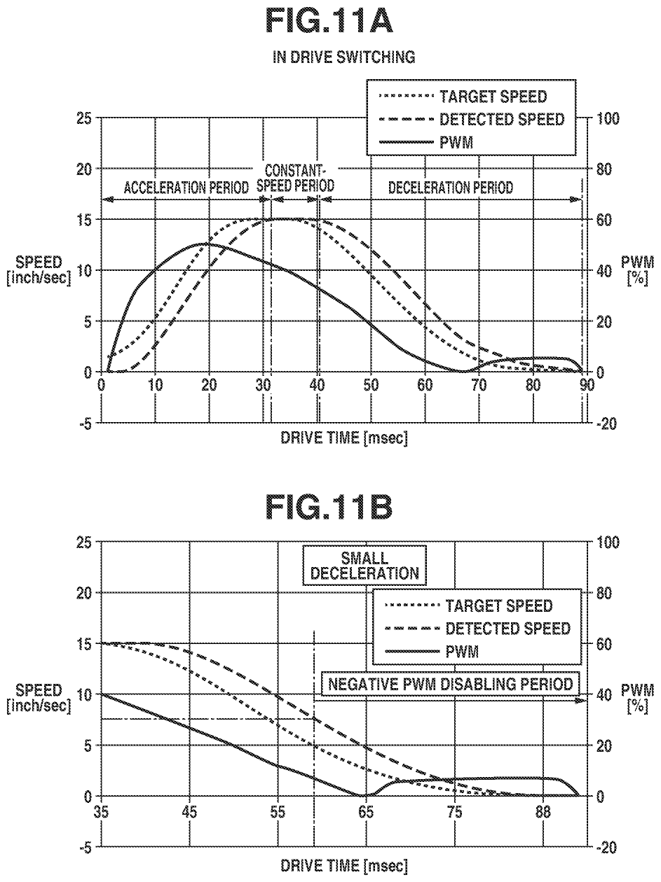

The profile of the drive motor 6 during the conveyance operation will be described below with reference to FIGS. 10A, 10B, 11A, and 11B. FIG. 10A is a conceptual view illustrating a profile of the drive motor 6 during the normal conveyance operation. FIG. 10B is an enlarged view illustrating the deceleration period during the normal conveyance operation. FIG. 11A is a conceptual view illustrating a profile of the drive motor 6 in the drive switching. FIG. 11B is an enlarged view illustrating the deceleration period in the drive switching. In each drawing, the dotted line indicates the target speed, the broken line indicates the detected speed, and the solid line indicates the duty ratio of the PWM.

The control unit 802 controls the drive motor 6 in the acceleration period, the constant-speed period, and the deceleration period. Therefore, the drive table can store all or a part of settings for controlling the drive motor 6, such as the acceleration, speed, and position in the acceleration period; the deceleration, speed, and position in the deceleration period; the predetermined speed (maximum speed) and position in the constant-speed period; and parameters for PID control. The drive motor 6 is controlled based on the difference between the speed detected by the encoder 813 and the target speed, and the drive table. As illustrated in FIGS. 10A and 10B, during the normal conveyance operation, the control unit 802 controls the drive motor 6 by increasing the absolute value of the deceleration in the deceleration period to reduce the sheet conveyance time. In this case, the control unit 802 applies a voltage with a negative duty ratio in the deceleration period to enable the conveyance roller 51 to stop at a target position. The error of the sheet stop position is restrained because of a small load variation of the drive system. When the control unit 802 applies a voltage with a negative duty ratio to the drive motor 6, it causes the rotation of the drive motor 6 to be reversed. More specifically, the control unit 802 can apply the brake to the drive motor 6 by using a negative duty ratio.

However, when the trailing edge of the sheet passes through the conveyance roller 51, a large load variation occurs in the drive system driven by the drive motor 6. If a load variation occurs when applying a voltage with a negative duty ratio in the deceleration period, the conveyance roller 51 may stop before the target position. Then, the drive motor 6 will accelerate again, and the conveyance roller 51 will end up exceeding the target position. Therefore, according to the present exemplary embodiment, the control unit 802 changes the drive table to reduce the influence of the load variation in the deceleration period. As illustrated in FIGS. 11A and 11B, in the deceleration period, the control unit 802 controls the drive motor 6 by making the absolute value of deceleration smaller than the absolute value for the normal conveyance operation. Further, the control unit 802 does not control the drive motor 6 by using a voltage with a negative duty ratio in a negative PWM disabling period.

As a result, the error of the sheet stop position is restrained.

A large absolute value of the deceleration refers to a relatively large gradient of the speed in the deceleration period, and a small absolute value of the deceleration refers to a relatively small gradient of the speed in the deceleration period. The deceleration is calculated based on the average value of the deceleration in the period since the deceleration starts till the drive stops. Alternatively, in a part of the deceleration period, the deceleration may be calculated based on the average value of the deceleration in the period since a set speed (e.g., a half of the predetermined speed) is reached till the sheet stops. Alternatively, the deceleration may be calculated based on the average value from 10 to 90% of the maximum speed. The deceleration can be reduced by setting PID parameters so as to prolong the deceleration period.

As described above, in at least a part of the deceleration period, the control unit 802 makes the deceleration of the drive motor 6 in a case where the trailing edge of the sheet stops in the predetermined regions smaller than the deceleration of the drive motor 6 in a case where the trailing edge of the sheet does not stop in the predetermined regions. As a result, a recording apparatus that solves the issue of the drive system of the conveyance roller can be provided.

A second exemplary embodiment will now be described. According to the first exemplary embodiment, to restrain the error of the sheet stop position, the control unit 802 selects the drive table in which the absolute value of the deceleration in the deceleration period is smaller than the absolute value for the normal conveyance operation. In this case, the control unit 802 restrains the error of the sheet stop position while reducing the conveyance time. According to the second exemplary embodiment, in a part of the deceleration period, the control unit 802 selects the drive table in which the absolute value of the deceleration since a certain set speed is reached till the sheet stops is smaller than the absolute value for the normal conveyance operation. The basic configuration is similar to that according to the first exemplary embodiment, only differences will be described below.

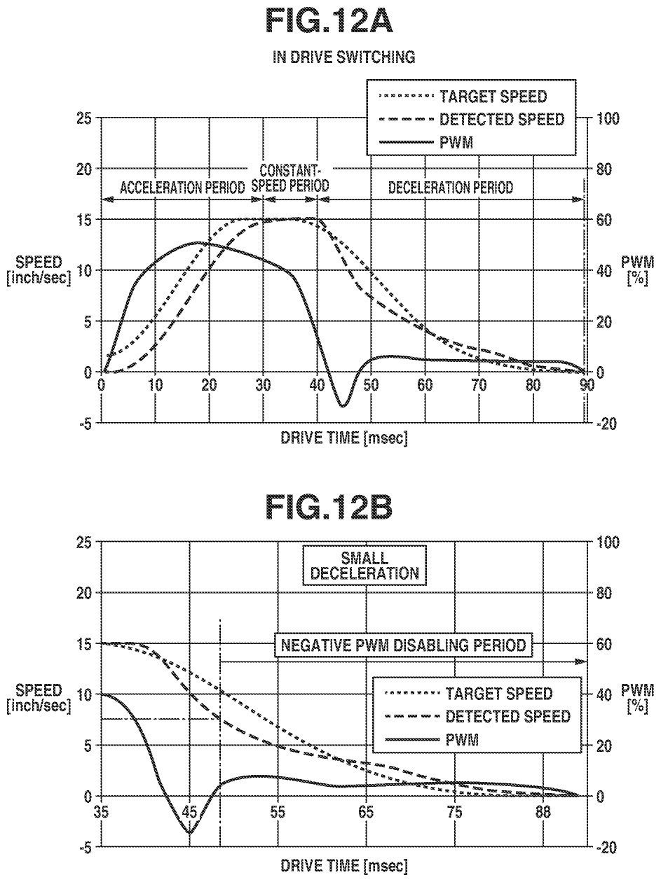

FIGS. 12A and 12B are conceptual views illustrating profiles of the drive motor 6 during the conveyance operation. FIG. 12A is a conceptual view illustrating a profile of the drive motor 6 in the drive switching. FIG. 12B is an enlarged view illustrating the deceleration period in the drive switching. In each drawing, the dotted line indicates the target speed, the broken line indicates the detected speed, and the solid line indicates the duty ratio of the PWM.

In step S204, the control unit 802 determines whether, during the conveyance operation immediately following the one-pass recording, the trailing edge position of the sheet stops within the range from the predetermined region C1 upstream of the conveyance roller 51 to the predetermined region C2 downstream thereof in the conveyance direction. If the trailing edge stops within the relevant range of the predetermined regions (YES in step S204), the processing proceeds to step S205.

In step S205, in at least a part of the deceleration period, the control unit 802 changes the drive table to make the absolute value of the deceleration smaller than the absolute value for the normal conveyance operation. At least a part of the period refers to, for example, a period during which the speed is equal to or lower than a half of a predetermined speed. Further, based on this drive table, the control unit 802 does not apply a voltage with a negative duty ratio to the drive motor 6 after a set speed lower than the predetermined speed (e.g., a half of the predetermined speed) is reached. Then, the processing returns to step S105. More specifically, the present exemplary embodiment permits the application of a voltage with a negative duty ratio at speeds exceeding the set speed.

Therefore, the present exemplary embodiment can reduce the conveyance time in comparison with the first exemplary embodiment. If the trailing edge position does not stop within the range from the predetermined region C1 upstream of the conveyance roller 51 to the predetermined region C2 downstream thereof in the conveyance direction, the control unit 802 leaves the drive control unchanged. Then, the processing returns to step S105.

The deceleration is calculated based on the average value of the deceleration in the period since the deceleration starts till the drive stops. Alternatively, in a part of the deceleration period, the deceleration may be calculated based on the average value of the deceleration in the period since a set speed is reached till the sheet stops.

The above-described configuration enables providing a recording apparatus that solves the issue relating to the drive system of the conveyance roller.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of priority from Japanese Patent Application No. 2023-069679, filed Apr. 20, 2023, which is hereby incorporated by reference herein in its entirety.

What is claimed is:

1. A recording apparatus comprising:
a recording unit configured to record an image onto a sheet;
a first conveyance roller configured to convey the sheet in a conveyance direction to the recording unit;
a motor configured to drive the first conveyance roller; and
a control unit configured to repetitively perform control for accelerating the motor in an acceleration period and then decelerating the motor in a deceleration period,
wherein, in at least a part of the deceleration period, the control unit makes an absolute value of a second deceleration in a second control of the motor smaller than an absolute value of a first deceleration in a first control of the motor, the first control being performed in a case where a trailing edge of the sheet in the conveyance direction does not stop in a first predetermined region, the second control being performed in a case where the trailing edge of the sheet stops in the first predetermined region.

2. The recording apparatus according to claim 1, where the first predetermined region is a region downstream of the first conveyance roller in the conveyance direction.

3. The recording apparatus according to claim 1, wherein the first predetermined region is a region ranging from an upstream of the first conveyance roller to a downstream of the first conveyance roller in the conveyance direction.

4. The recording apparatus according to claim 1, wherein, in a case where the trailing edge of the sheet does not stop within the first predetermined region when passing through the first conveyance roller, the control unit performs the first control.

5. The recording apparatus according to claim 1, wherein, in the deceleration period, the first and the second decelerations are average values of deceleration since deceleration starts till the sheet stops.

6. The recording apparatus according to claim 1, wherein, in the deceleration period, the first and the second decelerations are average values of deceleration since a set speed smaller than a predetermined speed between the acceleration and the deceleration periods is reached till the sheet stops.

7. The recording apparatus according to claim 1,
wherein the control unit causes the first conveyance roller to rotate in a forward direction by applying a first voltage to the motor, and causes the first conveyance roller to rotate in a reverse direction opposite to the forward direction by applying a second voltage different from the first voltage to the motor, and
wherein the control unit changes the polarity of the voltage in a deceleration period in the first control and leaves the polarity of the voltage unchanged in a deceleration period in the second control.

8. The recording apparatus according to claim 1,
wherein the control unit controls the motor with a pulse width modulation for changing a pulse duty ratio,
wherein the first control includes a period for applying a negative pulse duty ratio, and
wherein the second control does not include a period for applying a negative pulse duty ratio.

9. The recording apparatus according to claim 1, further comprising a detection unit configured to detect edges of the conveyed sheet in the conveyance direction, wherein a trailing edge position of the sheet is calculated based on a detection result by the detection unit.

10. The recording apparatus according to claim 9,
wherein, in a case where the trailing edge of the sheet is detected by the detection unit, the trailing edge position of the sheet is calculated based on a conveyance amount of the sheet after the detection of the trailing edge of the sheet, and
wherein, in a case where the trailing edge of the sheet is not detected by the detection unit, the trailing edge position of the sheet is calculated based on the conveyance amount of the sheet after the detection of a leading edge of the sheet.

11. The recording apparatus according to claim 1, further comprising a second conveyance roller disposed upstream of the first conveyance roller in the conveyance direction, wherein the control unit makes the absolute value of the second deceleration in the second control of the motor smaller than the absolute value of the first deceleration in the first control of the motor, the first control being performed in a case where the trailing edge of the sheet in the conveyance direction does not stop in a second predetermined region including the second conveyance roller, the second control being performed in a case where the trailing edge of the sheet stops in the second predetermined region.

12. The recording apparatus according to claim 1, further comprising a recording head configured to discharge ink onto a sheet while moving in a sheet width direction perpendicularly intersecting with the conveyance direction, wherein the control unit alternately performs the recording by the recording head and the conveyance by the first conveyance roller.
